(19) United States
(12) Patent Application Publication
(10) Pub. No.: US 2018/0070093 A1
(43) Pub. Date: Mar. 8, 2018

(54) DISPLAY APPARATUS AND CONTROL METHOD THEREOF

(71) Applicant: SAMSUNG ELECTRONICS CO., LTD., Suwon-si (KR)

(72) Inventors: Hee-won SHIN, Seoul (KR); Seung-bok KIM, Gwacheon-si (KR); Se-hyun KIM, Daejeon (KR); Tae-young LEE, Suwon-si (KR); Cheul-hee HAHM, Seongnam-si (KR)

(73) Assignee: SAMSUNG ELECTRONICS CO., LTD., Suwon-si (KR)

(21) Appl. No.: 15/688,076

(22) Filed: Aug. 28, 2017

(30) Foreign Application Priority Data
Sep. 7, 2016 (KR) 10-2016-0115170

(51) Int. Cl. H04N 19/162; G06F 3/01; G06F 9/44

(52) U.S. Cl. CPC H04N 19/162; G06F 9/443; G06F 3/013

(57) ABSTRACT

Predicting which of content presented to a user on a graphical user interface of a display apparatus will be selected by the user and performing preliminary image processing on the predicted content to shorten image processing time for reproducing the content if the content is actually selected by the user for reproduction.

### CROSS-REFERENCE TO RELATED the APPLICATION

This application claims priority from Korean Patent Application No. 10-2016-0115170 filed on Sep. 7, 2016, in the Korean Intellectual Property Office, the disclosure of which is incorporated herein by reference in its entirety.

### BACKGROUND

### 1. Field

Apparatuses and methods consistent with exemplary embodiments of the present application relate to a display apparatus and a control method thereof, and more particularly to a display apparatus for processing an image to reproduce content and a control method thereof.

### 2. Description of the Related Art

In terms of reproducing a moving image in a television (TV) or a mobile device, if a user selects one of moving image items displayed on a screen, a corresponding moving image file is subjected to an image processing upon selection thereof, to thereby reproduce the moving image.

In general, the image processing is performed with regard to at least one unit frame of the moving image, and includes various procedures such as demultiplexing, decoding, scaling, etc. to be applied to an encoded and compressed moving image.

Thus, it takes time for the image processing, and therefore there may exist a delay between a time of the user selection to a time of reproducing the moving image on the screen, and it is therefore inconvenient for a user to wait for the reproduction of the moving image.

Further, if the TV or the mobile device simultaneously performs many functions, more time will be required to reproduce the moving image due to limited hardware resources.

### SUMMARY

Accordingly, an aspect of one or more exemplary embodiments may provide a display apparatus and a control method thereof, which can shorten a waiting time of a user upon selection of content to be reproduced.

According to an aspect of an exemplary embodiment, there is provided a display apparatus including: an image processor configured to perform image processing on an image signal of video content; a display configured to display an image of the video content based on the image signal subjected to the image processing of the image processor; a user interface configured to receive user input; and a processor configured to control the display to display a graphical user interface comprising a plurality of items respectively corresponding to a plurality of pieces of video content, predict video content corresponding to an item that a user will select among the plurality of displayed items, and control the image processor to apply preliminary image processing on the video content, and in response to the user interface receiving the user input selecting the video content for reproduction, apply image processing on the video content to display the image of the video content.

According to this exemplary embodiment, in terms of reproducing the content, it is possible to shorten a waiting time of a user once the content is selected to be reproduced. Further, it is possible to reduce time taken in performing the image processes for reproducing the content.

The controller may predict the video content based on interest of the user, and determine the interest of the user based on at least one among clicking times, a cursor keeping time, an eye fixing time of a user, user control times and screen displaying times with regard to a plurality of items Thus, it is possible to determine content, in which a user is highly interested, by a user's input pattern, eye line, etc. with regard to many pieces of content displayed on a screen.

The controller may predict the video content based on a correlation with content currently reproduced or content previously reproduced, and the correlation is high based on a storing time, a storing location, a production time, a production place, a content genre, a content name and a successive correlation Thus, it is possible to determine the content having a high correlation based on a user's reproduction history with regard to many pieces of content displayed on the screen.

The processor may predict the video content based on frequency of selection of the video content for reproduction by the user Thus, it is possible to determine the content having a high correlation with the frequently reproduced content based on a user's reproduction history.

The processor may predict the video content based on correlation with most recently reproduced video content Thus, it is possible to determine the content having a high correlation with the most recently reproduced content based on a user's reproduction history.

The processor may determine additional video content corresponding to at least one item adjacent to the item of the video content among the plurality of items, and control the image processor to perform preliminary image processing on the additional video content Thus, it is possible to preliminarily apply some among the image processing to even content up, down, left, right and diagonally adjacent to the content determined to be highly selectable based on a user's input pattern, eye line, etc.

The image processing may include demultiplexing and decoding, and the preliminary image processing may be the demultiplexing. Thus, it is possible to determine content highly selectable based on a user's interest or a correlation with the reproduction history and preliminarily apply the demultiplexing among the entire image processing to the determined content.

The processor may store codec information, video data information and audio data information extracted by applying the demultiplexing to the image signal of the video content in a buffer, and perform decoding based on the information stored in the buffer in response to the user input selecting the video content for reproduction. Thus, information extracted by preliminarily applying the demultiplexing to content that a user is highly likely to select is stored, and the decoding is performed based on the stored information when a user actually selects the content.

The processor may control the image processor to perform the demultiplexing and the decoding on the image signal. Thus, content that a user is highly likely to select is preliminarily subjected to the decoding as well as the demultiplexing, and thus directly reproduced once selected by a user.

The display apparatus may further include a communication interface configured to communicate with an external apparatus that stores the plurality of pieces of video content, wherein the processor may control the communication interface to receive the video content, which corresponds to the item, from the external apparatus, and controls the received video content to be subjected to the preliminary image processing. Thus, if content is stored in a server or the external apparatus, content that a user is highly likely to select is previously received from the server or the external apparatus and preliminarily subjected to some of the image processing, and it is therefore possible to shorten the waiting time of the user until the content is reproduced from its selection.

According to an aspect of an exemplary embodiment, there is provided a method of controlling a display apparatus, the method including: displaying a plurality of items respectively corresponding to a plurality of pieces of video content on a graphical user interface of the display apparatus; predicting video content corresponding to an item that a user will select among the plurality of displayed items; applying preliminary image processing on the video content; and in response to user input selecting the video content for reproduction, applying image processing on the video content to display an image of the video content.

According to this exemplary embodiment, in terms of reproducing the content, it is possible to shorten a waiting time of a user until the content is reproduced. Further, it is possible to reduce time taken in performing the image processes for reproducing the content.

The predicting may include predicting based on interest of the user, and method may include determining the interest of the user based on at least one among clicking times, a cursor keeping time, an eye fixing time of a user, user control times and screen displaying times with regard to a plurality of items. Thus, it is possible to determine content, in which a user is highly interested, by a user's input pattern, eye line, etc. with regard to many pieces of content displayed on a screen.

The predicting may include predicting the video content based on a correlation with content currently reproduced or content previously reproduced, and the correlation is high based on a storing location, a production time, a production place, a content genre, a content name and a successive correlation. Thus, it is possible to determine the content having a high correlation based on a user's reproduction history with regard to many pieces of content displayed on the screen.

The predicting may be based on frequency of selection of the video content for reproduction by the user. Thus, it is possible to determine the content having a high correlation with the frequently reproduced content based on a user's reproduction history.

The predicting may include predicting the video content based on a correlation with most recently reproduced video content. Thus, it is possible to determine the content having a high correlation with the most recently reproduced content based on a user's reproduction history.

The method may further include determining additional video content corresponding to at least one item adjacent to the item of the video content among the plurality of menu and performing preliminary image processing on the additional video content. Thus, it is possible to preliminarily apply some among the image processes to even content up, down, left, right and diagonally adjacent to the content determined to be highly selectable based on a user's input pattern, eye line, etc.

The image processing may include at least one of the demultiplexing and decoding, and the preliminary image processing comprises the demultiplexing, and the preliminary image processing may include the demultiplexing. Thus, it is possible to determine content highly selectable based on a user's interest or a correlation with the reproduction history and preliminarily apply the demultiplexing among the entire image processing to the determined content.

The method may further include: storing codec information, video data information and audio data information extracted by applying the demultiplexing to the image signal of the video content, in a buffer; and performing decoding based on the information stored in the buffer in response to the user input selecting the video content for reproduction. Thus, information extracted by preliminarily applying the demultiplexing to content that a user is highly likely to select is stored, and the decoding is performed based on the stored information when a user actually selects the content.

The method may further include: performing the demultiplexing and the decoding on the image signal of the video content. Thus, content that a user is highly likely to select is preliminarily subjected to the decoding as well as the demultiplexing, and thus directly reproduced when it is selected by a user.

The method may further include: communicating with an external apparatus that stores the plurality of pieces of video content; receiving the video content, which corresponds to the item, from the external apparatus; and performing the preliminary image processing on the video content. Thus, if content is stored in a server or the external apparatus, content that a user is highly likely to select is previously received from the server or the external apparatus and preliminarily subjected to some of the image processing, and it is therefore possible to shorten the waiting time of the user until the content is reproduced from its selection.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates a block diagram of a display apparatus according to an exemplary embodiment;

FIG. 2 illustrates an example of determining content that a user is highly likely to select, based on a user's interest in a menu item according to an exemplary embodiment;

FIG. 3 illustrates an example of determining content that a user is highly likely to select, based on a user's interest in a menu item according to an exemplary embodiment;

FIG. 4 illustrates an example of determining content that a user is highly likely to select, based on a correlation with currently reproducing or previously reproduced content according to an exemplary embodiment;

FIG. 5 illustrates an example of performing at least some image processing with regard to an item adjacent to a menu item in which a user is highly interested, according to an exemplary embodiment;

FIG. 6 illustrates an example of overall image processing for content according to an exemplary embodiment;

FIG. 7 illustrates an example of image processing for content that a user is highly likely to select, according to an exemplary embodiment;

FIG. 8 illustrates an example of image processing when content that a user is highly likely to select is changed according to an exemplary embodiment;

FIG. 9 illustrates an example of image processing with regard to content adjacent to content that a user is highly likely to select according to an exemplary embodiment; and

FIG. 10 illustrates a flowchart of controlling a display apparatus according to an exemplary embodiment.

### DETAILED DESCRIPTION OF EXEMPLARY EMBODIMENTS

Hereinafter, exemplary embodiments will be described in detail with reference to accompanying drawings so as to be easily materialized by a person having ordinary knowledge in the art to which the present application relates. The present disclosure may be achieved in various forms and not limited to the following embodiments. For clear description, like numerals refer to like elements throughout.

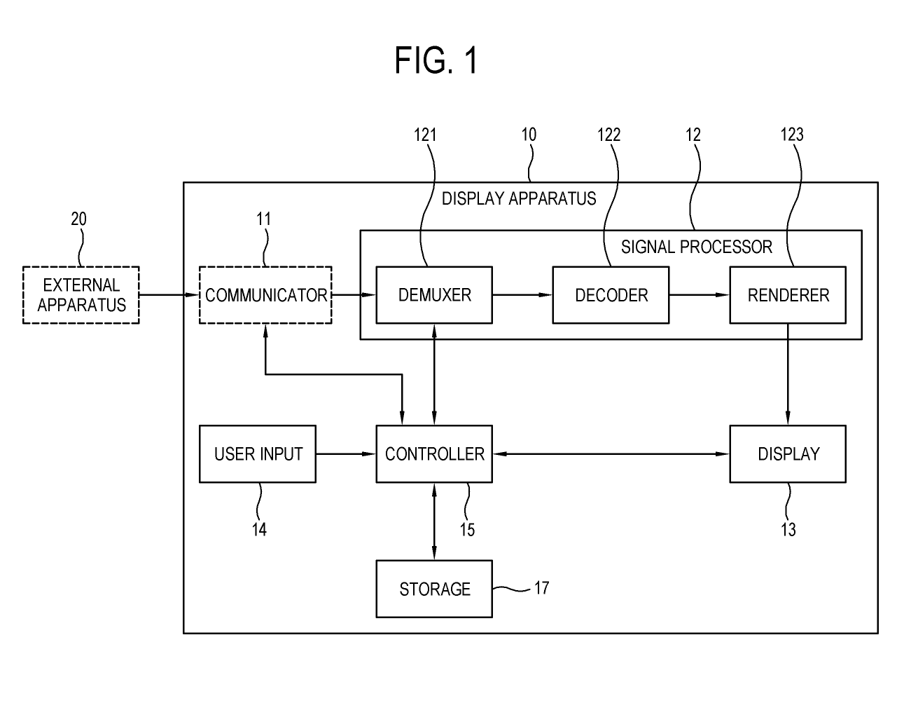

Below, features and embodiments of a display apparatus 10 will be first described with reference to FIG. 1 to FIG. 5.

FIG. 1 illustrates a block diagram of a display apparatus according to an exemplary embodiment.

As shown in FIG. 1, a display apparatus 10 according to this exemplary embodiment includes a signal processor 12, a display 13, a user input 14, a controller 15 and a storage 17. For example, the display apparatus 10 may be embodied as a television (TV), a smart phone, a tablet personal computer, a computer, etc. The display apparatus 10 may further include a communicator 11, which may be a wired (e.g., Ethernet, optical, etc.) or wireless (e.g., WiFi, Bluetooth, etc.) communication interface. In this case, the display apparatus 10 may connect with an external apparatus 20 through the communicator 11 by wired or wireless communication.

The external apparatus 20 may be materialized by a content providing server that stores a plurality of pieces of moving image content and provides the moving image content in response to a request of the display apparatus 10. The external apparatus 20 may be materialized by a web server that provides various pieces of content such as a plurality of moving images, still images, pictures and images, etc. on an Internet web page. Further, the external apparatus 20 may be materialized by a mobile device such as a smart phone, a tablet personal computer, etc. If the external apparatus 20 is materialized by the mobile device, the display apparatus 10 may directly connect with the mobile device through wireless communication and receive various pieces of content stored in the mobile device. The elements of the display apparatus 10 are not limited to the foregoing descriptions, and may exclude some elements or include some additional elements.

The signal processor 12 performs image processing preset with regard to an image signal of content. The signal processor 12 includes a demuxer 121 (i.e., demultiplexer), a decoder 122 and a renderer 123, which implement some of the image processing. Besides, the image processing performed in the signal processor 12 may further include de-interlacing, scaling, noise reduction, detail enhancement, etc. without limitation. The signal processor 12 may be materialized by a system on chip (SoC) in which many functions are integrated, or an image processing board on which individual modules for independently performing respective processes are mounted.

The demuxer 121 performs demultiplexes an image signal. That is, the demuxer 121 extracts a series of pieces of bit-stream data from the image signal of the content. For example, the demuxer 121 demultiplexes a compressed moving image stored in the display apparatus 10 or received from the external apparatus 20, thereby extracting audio/video (A/V) codec information and A/V bit-stream data. By such a demultiplexing operation, it is possible to determine a codec is used for encoding the moving image, and thus decode the moving image.

The decoder 122 performs decoding based on the A/V codec information and the A/V bit-stream data of the moving image extracted by the demuxer 121. For example, the decoder 122 acquires an original data image from the A/V bit-stream data based on the A/V codec information extracted by the demuxer 121. That is, video codec information is used to generate video pixel data from video bit-stream data, and audio codec information is used to generate audio pulse code modulation (PCM) data from audio bit-stream data.

The renderer 123 performs rendering to display the restored original data image acquired by the decoder 122 on the display 13. For example, the renderer 123 performs a process of editing an image to output the video pixel data generated by the decoding to a screen. Such a rendering operation processes information about object arrangement, a point of view, texture mapping, lighting and shading, etc., thereby generating a digital image or a graphic image to be output to the screen. The rendering may be for example implemented in a graphic processing unit (GPU).

The display 13 displays an image based on a broadcast signal processed by the signal processor 12. The display 13 may be implemented in various ways. For example, the display 13 may be implemented by a plasma display panel (PDP), a liquid crystal display (LCD), an organic light emitting diode (OLED), a flexible display, etc. without limitations.

The user input 14 receives a user's input for controlling at least one function of the display apparatus 10. For example, the user input 14 may receive a user's input for selecting a portion of a user interface displayed on the display 13. The user input 14 may be materialized by an input panel provided outside the display apparatus 10 or a remote controller using infrared light to communicate with the display apparatus 10. Further, the user input 14 may be materialized by a keyboard, a mouse and the like connected to the display apparatus 10 and a touch screen provided in the display apparatus 10.

The storage 17 stores a plurality of pieces of content reproducible in the display apparatus 10. The storage stores content received from the external apparatus 20 through the communicator 11, or stores the content acquired from a universal serial bus (USB) memory or the like directly connected to the display apparatus 10. The storage 17 may perform reading, writing, editing, deleting, updating, etc. with regard to data of the stored content. The storage 17 is materialized by a flash memory, a hard-disc drive or the like nonvolatile memory to retain data regardless of whether the display apparatus 10 is turned on or off.

The communicator 11 communicates with the external apparatus 20 storing the plurality of pieces of content by a wired or wireless communication method. The communicator 11 may use the wired communication method such as Ethernet or the like to communicate with the external apparatus 20, or may use the wireless communication method such as Wi-Fi or Bluetooth, etc. to communicate with the external apparatus 20 through a wireless router or directly via a peer-to-peer connection. For example, the communicator 11 may be materialized by a printed circuit board (PCB) including a module for Wi-Fi or the like wireless communication module. However, there are no limits to the foregoing communication method of the communicator 11, and another communication method may be used to communicate with the external apparatus 20.

The controller 15 is materialized by at least one processor that controls execution of a computer program so that all elements of the display apparatus 10 can operate. At least one processor may be achieved by a central processing unit (CPU), and administer three areas of: control, computation and register. In the control area, a program command is interpreted to control the elements of the display apparatus 10 to operate in response to the interpreted command. In the computation area, an arithmetic computation and a logic In the computation area, computer program instructions are executed to perform computations needed for operating the respective elements of the display apparatus 10 in response to the command of the control area. The register area refers to a memory location for storing pieces of information required while the CPU executes a command, in which the command and data for the respective elements of the display apparatus 10 are stored and the computed results are stored.

The controller 15 controls the display 13 to display a plurality of menu items (e.g., icons, links, thumbnails, etc.) respectively corresponding to a plurality of pieces of content. Here, the content may be stored in the display apparatus 10 or received from the external apparatus 20, and may for example include a moving image, a still image, a picture and an image, etc. Further, the content may include a plurality of applications to be executed in the display apparatus 10. The menu item may be for example displayed in the form of a thumbnail image, an image, a text or the like corresponding to the content. However, the menu item may be displayed in various forms without being limited to the foregoing forms.

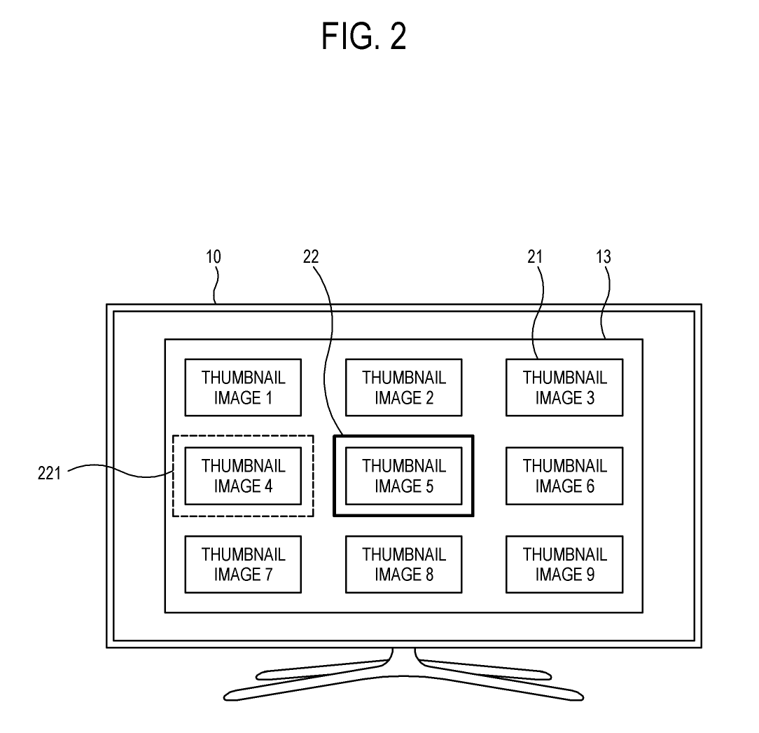

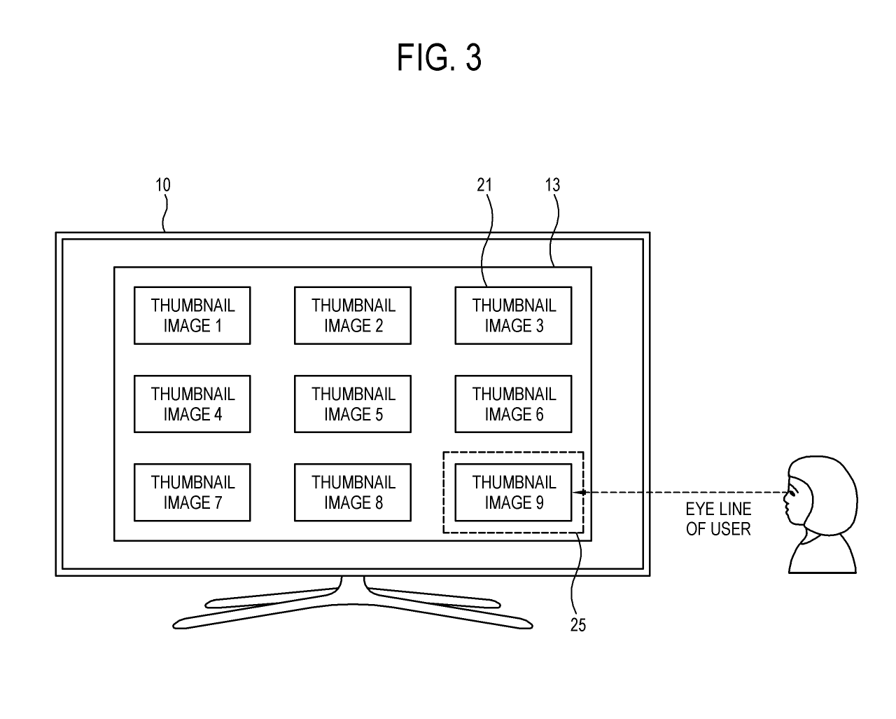

The controller 15 determines first content corresponding to a menu item that a user is highly likely to select among the plurality of menu items displayed on the display 13. According to an exemplary embodiment, the controller 15 may determine the likelihood of selecting the menu item based on a user's interest. At this time, a user's interest may be determined based on at least one of clicking times, a cursor keeping time, an eye fixing time, user control times and screen displaying times with regard to a plurality of menu items. For example, as shown in FIG. 2, if a cursor focused on a ‘thumbnail image 5’ 22 among the plurality of thumbnail images 21 displayed on the screen is maintained for a predetermined period of time, the ‘thumbnail image 5’ 22 is regarded as content of which a user is highly interested and thus determined as content that a user is highly likely to select. Alternatively, as shown in FIG. 3, if an eye fixing time of a user who gazes at a ‘thumbnail image 9’ 25 among the plurality of thumbnail images 21 displayed on the screen is longer than a predetermined period of time, the ‘thumbnail image 9’ 25 is regarded as content of which a user is highly interested and thus determined as content that a user is highly likely to select.

According to an exemplary embodiment, the controller 15 may determine the likelihood of selecting content based on a correlation with currently reproducing or previously reproduced content. At this time, if pieces of content are similar to each other in terms of a storing time, a storing location, a production time, a production place, a content genre, a content name and a successive correlation, it may be determined that a correlation between them is high. Here, the content having a high correlation may refer to content reproduced many times. Further, the content having a high correlation may refer to content reproduced most recently.

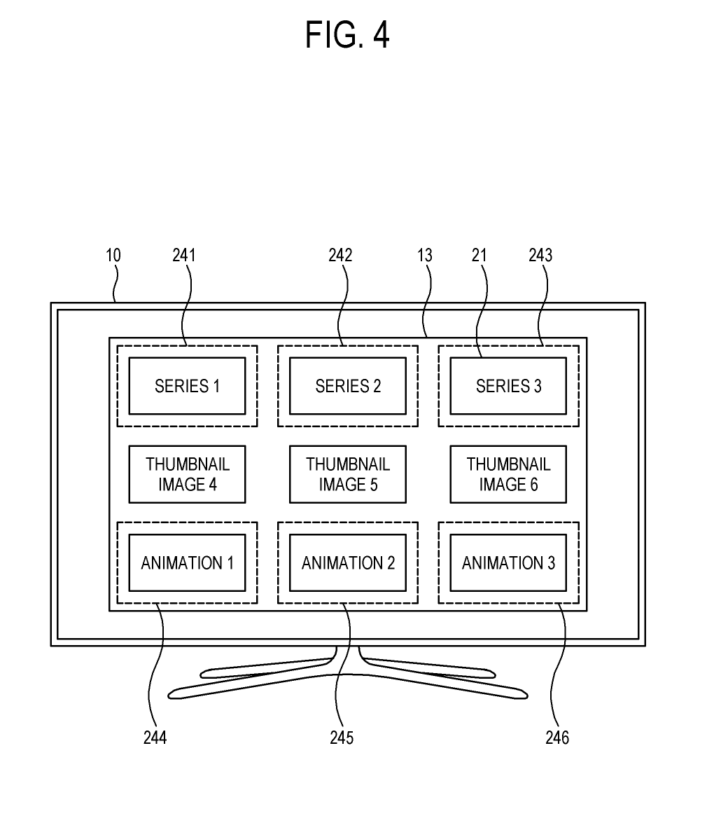

For example, as shown in FIG. 4, if the most recently reproduced content is a ‘series 1’ 241 among the plurality of thumbnail images 21 displayed on the screen, a ‘series 2’ 242 and a ‘series 3’ 243 having the successive correlation with the ‘series 1’ 241 may be determined as content that a user is highly likely to select. Alternatively, if content highly frequently reproduced by a user is categorized into an animation genre, an ‘animation 1’ 244, an ‘animation 2’ 245 and an ‘animation 3’ 246 may be determined as content that a user is highly likely to select.

The controller 15 performs at least some preliminary image processing with regard to the determined first content. Here, the image processing includes the demultiplexing and the decoding with regard to at least one unit frame included in an image signal of content. The controller 15 performs the demultiplexing as the preliminary process with regard to the image signal of the determined first content. Here, the controller 15 controls codec information, video data information and audio data information, which are extracted by applying the demultiplexing to the image signal of the first content, to be stored in a buffer.

At least some preliminary image processing is not limited to the demultiplexing. In consideration of time taken in the image processing, a process corresponding to a predetermined time section among overall image processing operations may be regarded as the preliminary process.

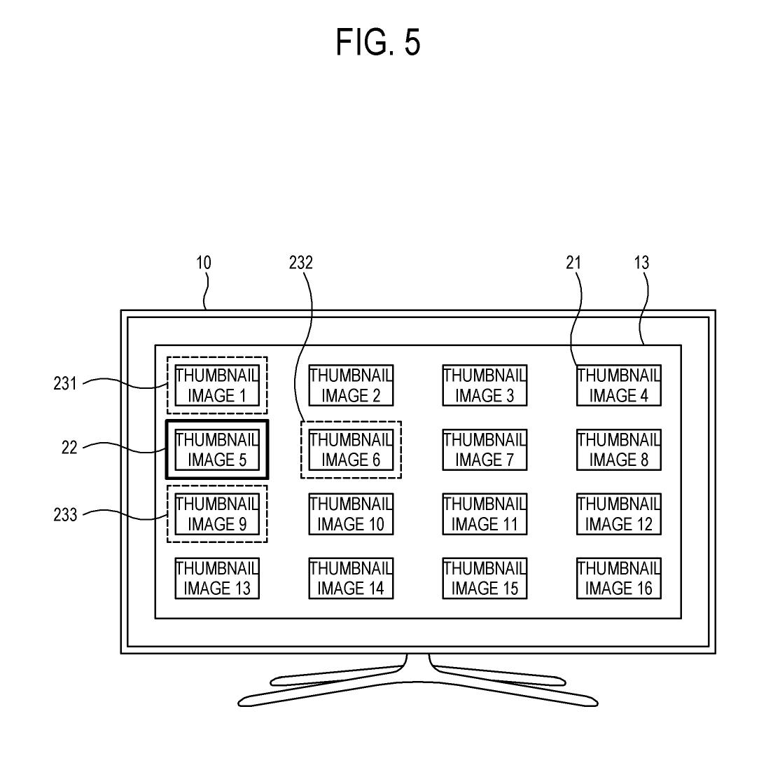

According to an exemplary embodiment, the controller may perform at least some preliminary image processing among the image processing with regard to second content corresponding to at least one menu item adjacent to the menu item of the first content determined among the plurality of menu items. For example, as shown in FIG. 5, if a cursor keeping time on a ‘thumbnail image 5’ 22 among the plurality of thumbnail images 21 displayed on the screen is longer than a predetermined period of time, the ‘thumbnail image 5’ 22 is determined as content that a user is highly likely to select, and subjected to the demultiplexing. At this time, a ‘thumbnail image 1’ 231, a ‘thumbnail image 6’ 232 and a ‘thumbnail image 9’ 233 adjacent to the ‘thumbnail image 5’ 22 are also determined as content that a user is highly likely to select, and subjected to the demultiplexing like the ‘thumbnail image 5’ 22.

According to an exemplary embodiment, even if a plurality of menu items corresponds to audio content, the controller 15 may determine the audio content, in which a user is highly interested or which has a high correlation with a currently reproducing or previously reproduced audio file, as first content corresponding to a menu item that a user is highly likely to select, and perform at least some preliminary processes with regard to the first content.

If the first content is selected in response to a user's input, the controller 15 controls the signal processor to make the first content subjected to at least some preliminary image processing subjected to the rest of the image processing, thereby displaying an image of the first content. According to an exemplary embodiment, the controller controls the buffer to store the codec information, the video data information and the audio data information, which are extracted by applying the demultiplexing to the image signal of the first content, and performs the decoding based on the information stored in the buffer when the first content is selected by a user's input.

According to an exemplary embodiment, the controller 15 may perform the demultiplexing and the decoding with regard to the image signal of the determined first content. That is, content that a user is highly likely to select is preliminarily subjected to the decoding as well as the demultiplexing, so that the decoded content can be directly reproduced upon selection by a user.

According to an exemplary embodiment, the controller 15 receives the first content, which is determined as content that a user highly likely to select among the plurality of menu items respectively corresponding to the plurality of pieces of content stored in the external apparatus 20, from the external apparatus 20, and applies at least some preliminary image processing to the received first content. Thus, if content is stored in an external server, content that a user is highly likely to select is previously received from the external server and subjected to some of the image processing, and it is therefore possible to shorten time taken in waiting for reproduction of the content upon selection by the user.

As described above, in terms of reproducing content, the display apparatus 10 according to an exemplary embodiment performs some of the preliminary image processing with regard to content that a user is highly likely to select, thereby shortening a waiting time of a user until the content is reproduced from its selection. Further, it is possible to shorten time taken in performing the image processing for the reproduction of the content.

FIG. 2 illustrates an example of determining content that a user is highly likely to select, based on a user's interest in a menu item according to an exemplary embodiment.

As shown in FIG. 2, the display apparatus 10 according to an exemplary embodiment determines that a user is highly interested in the ‘thumbnail image 5’ 22 if a cursor focused on the ‘thumbnail image 5’ 22 among the plurality of thumbnail images 21 displayed on the display 13 is maintained for a predetermined period of time. At this time, the cursor is displayed with respect to the plurality of thumbnail images 21 on the screen, in response to a mouse or keyboard input or a touch input.

The display apparatus 10 determines the ‘thumbnail image 5’ 22 in which a user is highly interested as content that the user is highly likely to select, and applies the demultiplexing to the content corresponding to the ‘thumbnail image 5’ 22. Thus, if a user clicks on the ‘thumbnail image 5’ 22, the decoding is performed based on the A/V codec information and the A/V bit-stream data preliminarily subjected to the demultiplexing and stored in the buffer. Accordingly, it is possible to more quickly reproduce the content of the ‘thumbnail image 5’ 22 than content not subjected to the preliminary image processing.

According to an exemplary embodiment, if a cursor focused on the ‘thumbnail image 5’ 22 among the plurality of thumbnail images 21 displayed on the display 13 is maintained for a predetermined period of time (or more) and then moved to a ‘thumbnail image 4’ 221, the display apparatus 10 deletes the codec and A/V data information about the ‘thumbnail image 5’ 22 from the buffer. Next, the display apparatus 10 extracts codec and A/V data information by applying the demultiplexing to the content of the ‘thumbnail image 4’ 221 and stores the codec and A/V data information in the buffer. Thus, even though the thumbnail image focused by the cursor is changed, the content of the changed thumbnail image is subjected to the demultiplexing and it is thus possible to shorten the time of waiting until the content is reproduced after selection of a user.

FIG. 3 illustrates an example of determining content that a user is highly likely to select, based on a user's interest in a menu item according to an exemplary embodiment.

As shown in FIG. 3, the display apparatus 10 according to an exemplary embodiment determines that a user is highly interested in the ‘thumbnail image 9’ 25, at which the user gazes for a predetermined period of time (or more), among the plurality of thumbnail images 21 displayed on the display 13. At this time, eye tracking technology is used to sense whether a user gazes at the image. The eye tracking technique employs a video analysis method that detects a motion of a pupil in real time through a camera image analysis and calculates a direction of a user's eyes with respect to a fixed position reflected on a thin film, thereby determining an eye line. Besides, the video analysis method, the eye tracking technology may use a contact lens method, a sensor mounting method, etc. to sense the eye line.

Alternatively, it may be determined that a user is highly interested in a thumbnail image, on which the user's eyes are focused a predetermined number of times, among the plurality of thumbnail images 21. That is, the thumbnail image, on which a user's eyes most frequently linger while the user's eyes are moving between the thumbnail images, is determined as a thumbnail image in which the user is highly interested.

The display apparatus 10 determines the ‘thumbnail image 9’ 25 having high interest to a user as content that the user is highly likely to select, and applies the demultiplexing to the content corresponding to the ‘thumbnail image 9’ 25. Thus, if a user clicks and selects the ‘thumbnail image 9’ 25, the ‘thumbnail image 9’ 25 is subjected to the decoding so that the content can be more quickly reproduced.

As described above, the examples of determining a user's interest in a plurality of menu items are not limited to the foregoing exemplary embodiments shown in FIG. 2 and FIG. 3. Alternatively, a user's interest in a plurality of menu items may be determined based on the number of menu-item clicking times, the number of user control times, the number of screen displaying times, etc. In addition, it may be possible to determine content that a user is highly interested in based on a moving speed, a moving pattern, etc. of a cursor and a user's eyes.

FIG. 4 illustrates an example of determining content that a user is highly likely to select, based on a correlation with currently reproducing or previously reproduced content according to an exemplary embodiment.

As shown in FIG. 4, the display apparatus 10 according to an exemplary embodiment may determine that a correlation between pieces of content is high if content are similar to the currently reproducing or previously reproduced content among the plurality of thumbnail images 21 displayed on the display 13 with respect to at least one of a content genre, a content name, a successive correlation, a storing time, a storing location, a production time and a production place. In terms of determining content having a high correlation, it is determined whether the content has a high correlation with the highly frequently or most recently reproduced content.

For example, if the most recently reproduced content is the ‘series 1’ 241 among the plurality of thumbnail images 21 displayed on the screen, the ‘series 2’ 242 and the ‘series 3’ 243 having the successive correlation with the ‘series 1’ 241 may be determined as content having a high correlation.

The display apparatus 10 determines the ‘series 2’ 242 and the ‘series 3’ 243 determined as having the high correlation with the currently reproducing or previously reproduced content as content that a user is highly likely to select, and applies the demultiplexing to the ‘series 2’ 242 and the ‘series 3’ 243. Accordingly, when a user clicks and selects the ‘series 2’ 242 and the ‘series 3’ 243, it is possible to more quickly reproduce the ‘series 2’ 242 and the ‘series 3’ 243 since they are directly subjected to the decoding.

Alternatively, if the content highly frequently reproduced by a user is categorized into the animation genre, the ‘animation 1’ 244, the ‘animation 2’ 245 and the ‘animation 3’ 246 corresponding to the animation genre among the plurality of thumbnail images 21 are determined as content that the user is highly like to select, and preliminarily subjected to the demultiplexing so as to be more quickly reproduced when the user selects one of them.

Like this, the content having a high correlation with the current reproducing or previously reproduced content among the plurality of menu items is determined as content that a user highly likely to select and preliminarily subjected to the demultiplexing, and it is therefore possible to shorten a time of waiting until the content is reproduced from the selection of the user.

FIG. 5 illustrates an example of performing at least some preliminary image processing among the image processes with regard to an item adjacent to a menu item in which a user is highly interested, according to an exemplary embodiment.

As shown in FIG. 5, the display apparatus 10 according to an exemplary embodiment determines that a user is highly likely to select the ‘thumbnail image 5’ 22, on which the focus of the cursor is maintained for a predetermined period of time, among the plurality of thumbnail images 21 displayed on the display 13, and applies the demultiplexing to the ‘thumbnail image 5’ 22. At this time, the ‘thumbnail image 1’ 231, the ‘thumbnail image 6’ 232 and the thumbnail image 9′ 233 adjacent to the ‘thumbnail image 5’ 22 are also determined to be highly selectable by the user and subjected to the demultiplexing like the ‘thumbnail image 5’ 22.

According to an exemplary embodiment, it is possible to apply a different preliminary image processing to the menu items adjacent to the menu item determined to be highly selectable by a user. For example, among the plurality of thumbnail images 21, the ‘thumbnail image 5’ 22 that a user is highly likely to select may be subjected to the demultiplexing and the decoding among the image processes, but the ‘thumbnail image 1’ 231, the ‘thumbnail image 6’ 232 and the thumbnail image 9′ 233 adjacent to the ‘thumbnail image 5’ 22 may be subjected to only the demultiplexing.

Alternatively, the ‘thumbnail image 5’ 22 that a user is highly likely to select may be subjected to a process corresponding to a first time section among the entire image processing, but the ‘thumbnail image 1’ 231, the ‘thumbnail image 6’ 232 and the thumbnail image 9′ 233 adjacent to the ‘thumbnail image 5’ 22 may be subjected to a image processing corresponding to a second time section shorter than the first time section among the entire image processing.

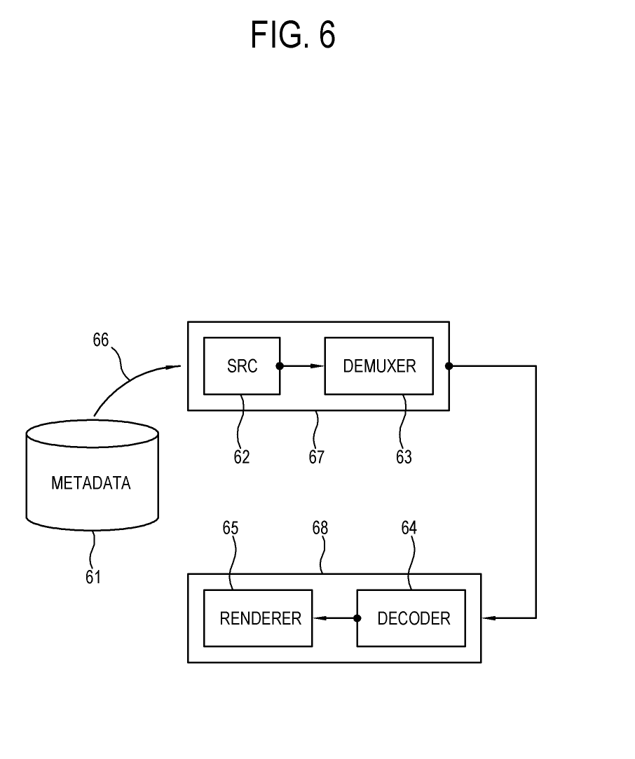

FIG. 6 illustrates an example of overall image processing for content according to an exemplary embodiment.

As shown in FIG. 6, overall image processing in the display apparatus 10 according to an exemplary embodiment includes image processing to be respectively performed by a demuxer 63, a decoder 64 and a renderer 65 with respect to content source data (SRC) 62. In the process 66, demultiplexing process data corresponding to a format of a compressed moving image is stored in a demuxer metadata 61, thereby setting information for operating the demuxer 63.

In the process 67, the demuxer 63 applies the demultiplexing to the content source data 62. Here, the content source data 62 may include the compressed moving image encoded by specific codec. The demuxer 63 looks up the demultiplexing process data corresponding to the format of the compressed moving image on the preset demuxer metadata 61. Thus, the demuxer 63 performs the demultiplexing suitable for the format of the compressed moving image.

The demuxer 63 extracts a series of bit-stream data from the compressed moving image. For example, the demuxer 63 applies the demultiplexing to the compressed moving image to thereby extract the A/V codec information and the A/V bit-stream data. By such a demultiplexing operation, it is possible to determine which codec is used for encoding the moving image, and thus decode the moving image.

The demuxer 63 temporarily stores the codec information and the A/V data information, which are extracted by performing the demultiplexing, in the buffer. The information stored in the buffer is used in the decoding of the decoder 64.

In the operation 68, the decoder 64 and the renderer 65 respectively perform the decoding and the rendering based on the codec information and A/V data extracted by the demultiplexing.

The decoder 64 performs the decoding based on the A/V codec information and the A/V bit-stream data extracted by the demuxer 63 and stored in the buffer. The decoder 64 acquires an original data image from the A/V bit-stream data based on the A/V codec information. That is, video codec information is used to generate video pixel data from video bit-stream data, and audio codec information is used to generate audio pulse code modulation (PCM) data from audio bit-stream data.

The renderer 65 performs rendering to display the original data image acquired by the decoder 64 on the display 13. For example, the renderer 65 performs a process of editing an image to output the video pixel data generated by the decoding to the screen. Such a rendering operation processes information about object arrangement, a point of view, texture mapping, lighting and shading, etc., thereby generating a digital image or a graphic image to be output to the screen. The rendering may be for example implemented through a graphic processing unit (GPU).

According to an exemplary embodiment, among the plurality of menu items to be displayed on the screen, the content that a user is highly likely to select is preliminarily subjected to the demultiplexing among the entire image processing, and it is possible to shorten a time of waiting until the content is reproduced from the selection of a user.

Alternatively, content that a user is highly likely to select may be subjected to the demultiplexing and the decoding among the entire image processes.

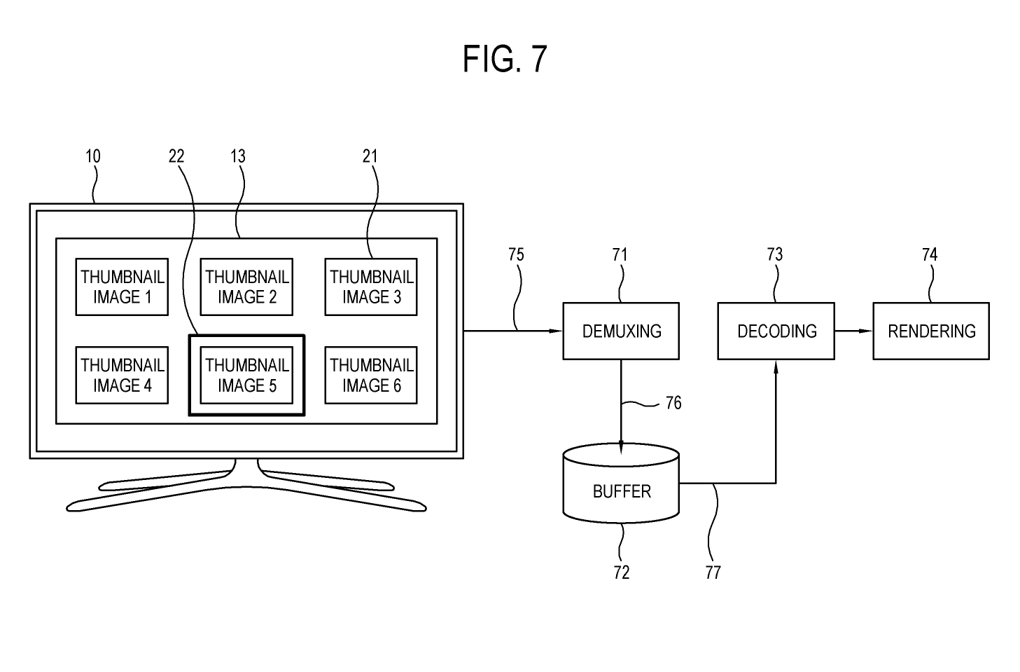

FIG. 7 illustrates an example of image processes for content that a user is highly likely to select, according to an exemplary embodiment.

As shown in FIG. 7, in the process 75, the display apparatus 10 according to an exemplary embodiment determines the ‘thumbnail image 5’ 22, on which the focus of the cursor is maintained for a predetermined period of time or more, as content that a user is highly likely to select among the plurality of thumbnail images 21 displayed on the display 13, and applies demultiplexing 71 to the compressed moving image of the ‘thumbnail image 5’ 22.

Next, in the process 76, the A/V codec information and the A/V bit-stream data extracted by performing the demultiplexing 71 are stored in a buffer 72. Next, in the process 77, if a user makes a click or the like activity to select the ‘thumbnail image 5’ 22, decoding 73 is performed based on the information stored in the buffer 72, and then rendering 74 is performed to thereby reproduce a moving image of the ‘thumbnail image 5’ 22 on the display 13.

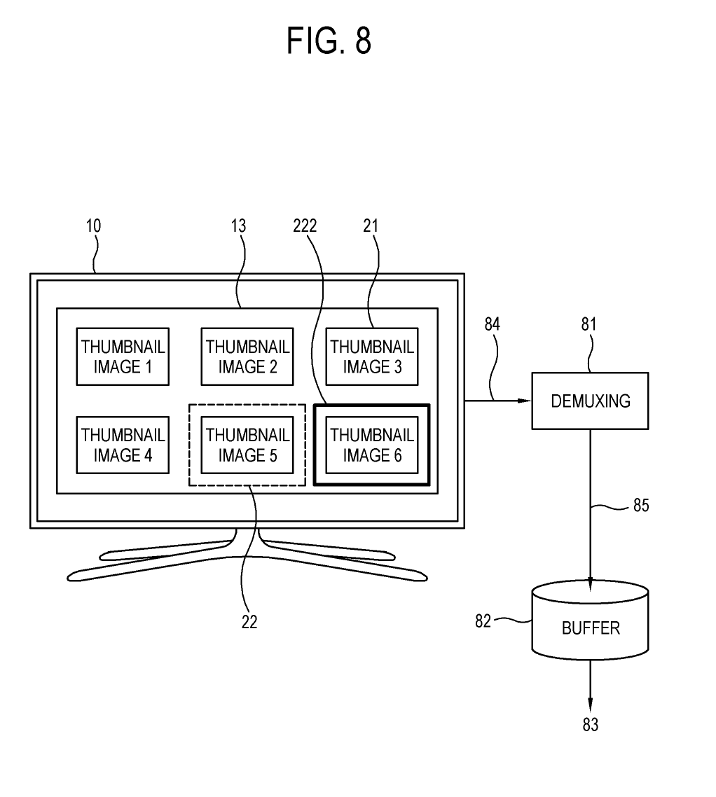

FIG. 8 illustrates an example of image processing when content that a user is highly likely to select is changed according to an exemplary embodiment.

As shown in FIG. 8, in the process 83, the display apparatus 10 according to an exemplary embodiment deletes the codec information and A/V data information about the ‘thumbnail image 5’ 22 from the buffer if a cursor focused on the ‘thumbnail image 5’ 22 among the plurality of thumbnail images 21 displayed on the display 13 is maintained for a predetermined period of time or more and then moved to the ‘thumbnail image 6’ 222.

Next, in the process 84, the display apparatus 10 determines the ‘thumbnail image 6’ 222 as content that a user is highly likely to select, and performs the demultiplexing 81 with regard to the compressed moving image of the ‘thumbnail image 6’ 222. Next, in the process 85, the A/V codec information and the A/V bit-stream data extracted by the demultiplexing 81 are stored in the buffer 82.

According to this exemplary embodiment, even though the thumbnail image focused by the cursor is changed, the content of the changed thumbnail image is directly subjected to the demultiplexing and it is thus possible to shorten a time of waiting until the content is reproduced from selection of a user.

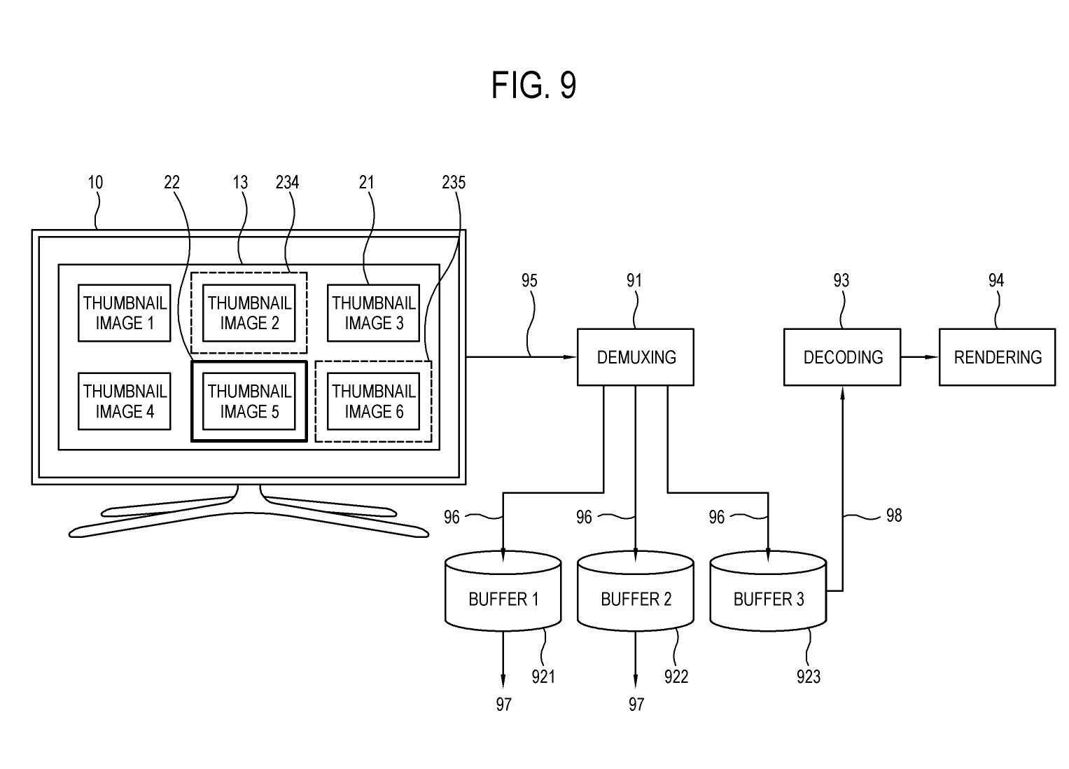

FIG. 9 illustrates an example of image processing with regard to content adjacent to content that a user is highly likely to select according to an exemplary embodiment.

As shown in FIG. 9, in the process 95, the display apparatus 10 according to an exemplary embodiment determines the ‘thumbnail image 5’ 22, on which the focus of the cursor is maintained for a predetermined period of time, among the plurality of thumbnail images 21 displayed on the display 13 as content that a user is highly likely to select, and performs the demultiplexing 91 with regard to the compressed moving image of the ‘thumbnail image 5’ 22. At this time, the ‘thumbnail image 2’ 234 and the ‘thumbnail image 6’ 235 adjacent to the ‘thumbnail image 5’ 22 are also determined as content that a user is highly likely to select, and subjected to the demultiplexing 91 like the ‘thumbnail image 5’ 22.

Next, in the process 96, the A/V codec information and the A/V bit-stream data of the ‘thumbnail image 5’ 22, which are extracted by the demultiplexing 91, are stored in a ‘buffer 1’ 921, and the codec information and the A/V bit-stream data of the adjacent content, i.e. the ‘thumbnail image 2’ 234 and the ‘thumbnail image 6’ 235 are respectively stored in a ‘buffer 2’ 922 and a ‘buffer 3’ 923.

Next, if a user makes a click or the like to select the ‘thumbnail image 6’ 235 among the pieces of adjacent content, in the process 97 information about the ‘thumbnail image 5’ 22 and the ‘thumbnail image 2’ 234 stored in the ‘buffer 1’ 921 and the ‘buffer 2’ 922. Next, in the process 98, the decoding 73 is performed using the information about the ‘thumbnail image 6’ 235 stored in the ‘buffer 3’ 923, and then the rendering 74 is performed so that the moving image of the ‘thumb image 6’ 235 can be reproduced on the display 13.

According to the foregoing exemplary embodiments, the content up, down, left, right or diagonally adjacent to the content determined to be highly selectable by a user based on the user's input pattern, eye line, etc. may be preliminarily subjected to some of the image processes.

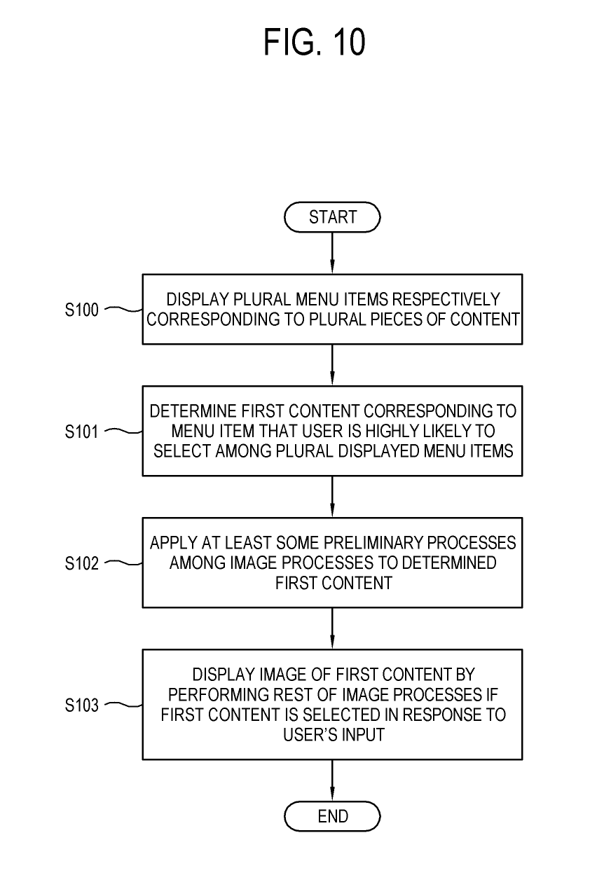

FIG. 10 illustrates a flowchart of controlling a display apparatus according to an exemplary embodiment.

As shown in FIG. 10, at operation S100, a plurality of menu items respectively corresponding to a plurality of pieces of content are displayed. The menu items may be for example displayed in the form of a thumbnail image, an image, a text, etc. corresponding to the content.

Next, at operation S101, first content corresponding to a menu item that a user is highly likely to select is determined among the plurality of displayed menu items. According to an exemplary embodiment, the operation S101 may include an operation of evaluating the likelihood of selecting the content based on a user's interest. The user's interest may be determined based on at least one of clicking times, a cursor keeping time, an eye fixing time, user control times and screen displaying times with regard to a plurality of menu items.

According to an exemplary embodiment, the operation S101 may include an operation of determining the likelihood of selecting the content based on a correlation with the currently reproducing or previously reproduced content. In this case, if pieces of content are similar to each other in terms of a storing time, a storing location, a production time, a production place, a content genre, a content name and a successive correlation, it may be determined that a correlation between them is high. To determine content having a high correlation, it may be determined whether the content has a high correlation with the highly frequently or most recently reproduced content.

Next, at operation S102, the determined first content is subjected to at least some preliminary image processing. The image processing may include the demultiplexing and the decoding with regard to at least one unit frame of a convent image signal, and thus the operation S102 may include applying the demultiplexing to the image signal of the determined first content. Further, the operation S102 may further include an operation of storing codec information, video data information and audio data information, which are extracted by applying the demultiplexing to the image signal of the determined first content, in the buffer.

According to an exemplary embodiment, the operation S102 may include applying the demultiplexing and the decoding to the image signal of the determined first content. That is, the first content determined to be likely selectable by a user is preliminarily subjected to the decoding as well as the demultiplexing within a limit allowable by hardware resources, so that the first content can be more quickly reproduced once selected by a user.

According to an exemplary embodiment, the first content corresponding to the menu item determined to be likely selectable by a user may be subjected to both the demultiplexing and the decoding, and pieces of content corresponding to menu items adjacent to the menu item of the first content may be subjected to only the demultiplexing. Like this, the plurality of pieces of highly selectable content may be differently subjected to various preliminary processes within the limit allowable by the hardware resources.

Last, at operation S103, if the first content is selected in response to a user's input, the preliminarily processed first content is subjected to the rest of the image processing so that an image of the first content can be displayed. Here, the rest of the image processing refers to other image processing to be performed after at least some preliminary image processing performed in the operation S102, and may for example include the decoding and the rendering.

Further, the operation S103 may include performing the decoding based on the information stored in the buffer in the operation S102.

As described above, in terms of reproducing content according to an exemplary embodiment, it is possible to shorten a waiting time of a user until the content is reproduced.

Further, in terms of reproducing content according to an exemplary embodiment, it is possible to reduce time taken in performing image processes for reproduction.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
an image processor configured to perform image processing on an image signal of video content;
a display configured to display an image of the video content based on the image signal subjected to the image processing of the image processor;
a user interface configured to receive user input; and
a processor configured to control the display to display a graphical user interface comprising a plurality of items respectively corresponding to a plurality of pieces of video content, predict video content corresponding to an item that a user will select among the plurality of displayed items, and control the image processor to apply first image processing on the video content, and in response to the user interface receiving the user input selecting the video content for reproduction, apply second image processing on the video content processed by the first image processing to display the image of the video content.

2. The display apparatus according to claim 1, wherein the processor predicts the video content based on interest of the user, and determines the interest of the user based on at least one among clicking times, a cursor keeping time, an eye fixing time of a user, user control times and screen displaying times with regard to a plurality of items.

3. The display apparatus according to claim 1, wherein the processor predicts the video content based on a correlation with content currently reproduced or content previously reproduced, and the correlation is high based on a storing time, a storing location, a production time, a production place, a content genre, a content name and a successive correlation.

4. The display apparatus according to claim 1, wherein the processor predicts the video content based on frequency of selection of the video content for reproduction by the user.

5. The display apparatus according to claim 1, wherein the processor predicts the video content based on correlation with most recently reproduced video content.

6. The display apparatus according to claim 1, wherein the processor determines additional video content corresponding to at least one item adjacent to the item of the video content among the plurality of items, and controls the image processor to perform the first image processing on the additional video content.

7. The display apparatus according to claim 1, wherein the image processing comprises at least one of demultiplexing and decoding, and the first image processing comprises the demultiplexing.

8. The display apparatus according to claim 7, wherein the processor stores codec information, video data information and audio data information extracted by applying the demultiplexing to the image signal of the video content in a buffer, and performs decoding based on the information stored in the buffer in response to the user input selecting the video content for reproduction.

9. The display apparatus according to claim 7, wherein the processor controls the image processor to perform the demultiplexing and the decoding on the image signal of the video content.

10. The display apparatus according to claim 1, further comprising a communication interface configured to communicate with an external apparatus that stores the plurality of pieces of video content,
wherein the processor controls the communication interface to receive the video content, which corresponds to the item, from the external apparatus, and controls the received video content to be subjected to the first image processing.

11. A method of controlling a display apparatus, the method comprising:
displaying a plurality of items respectively corresponding to a plurality of pieces of video content on a graphical user interface of the display apparatus;
predicting video content corresponding to an item that a user will select among the plurality of displayed items;
applying first image processing on the video content; and
in response to user input selecting the video content for reproduction, applying second image processing on the video content processed by the first image processing to display an image of the video content.

12. The method according to claim 11, wherein the predicting is based on interest of the user, and
wherein the method further comprises determining the interest of the user based on at least one among clicking times, a cursor keeping time, an eye fixing time of a user, user control times and screen displaying times with regard to a plurality of items.

13. The method according to claim 11, wherein the predicting comprises predicting the video content based on a correlation with content currently reproduced or content previously reproduced, and the correlation is high based on a storing location, a production time, a production place, a content genre, a content name and a successive correlation.

14. The method according to claim 11, wherein the predicting is based on frequency of selection of the video content for reproduction by the user.

15. The method according to claim 11, wherein the predicting comprises predicting the video content based on a correlation with most recently reproduced video content.

16. The method according to claim 11, further comprising determining additional video content corresponding to at least one item adjacent to the item of the video content among the plurality of menu and performing the first image processing on the additional video content.

17. The method according to claim 11, wherein the image processing comprises at least one of the demultiplexing and decoding, and the first image processing comprises the demultiplexing.

18. The method according to claim 17, further comprising:
storing codec information, video data information and audio data information extracted by applying the demultiplexing to the image signal of the video content, in a buffer; and
performing decoding based on the information stored in the buffer in response to the user input selecting the video content for reproduction.

19. A computer program product comprising:
a memory configured to store instructions; and
a processor, wherein the instructions, when executed by a computing device, causes the computing device:
to display a graphical user interface comprising a plurality of items respectively corresponding to a plurality of pieces of video content,
to predict video content corresponding to an item that a user will select among the plurality of displayed items, and
to apply first image processing on the video content, and
in response to receiving a user input selecting the video content for reproduction, to apply second image processing on the video content processed by the first image processing to display the image of the video content.

20. The computer program product of claim 19, wherein the instructions are stored in the memory in a server and wherein the instructions are downloaded over a network to the computing device.
